(19) United States
(12) Patent Application Publication
(10) Pub. No.: US 2025/0301368 A1
(43) Pub. Date: Sep. 25, 2025

(54) METHODS AND SYSTEMS FOR EFFICIENT TRANSMISSION FOR EXTENDED REALITY

(71) Applicant: Samsung Electronics Co., Ltd., Suwon-si (KR)

(72) Inventors: Vinay Kumar SHRIVASTAVA, Bangalore (IN); Sangkyu BAEK, Suwon-si (KR)

(21) Appl. No.: 19/087,922

(22) Filed: Mar. 24, 2025

(30) Foreign Application Priority Data
Mar. 23, 2024 (IN) 202441022753
Nov. 14, 2024 (IN) 202441088302
Mar. 11, 2025 (IN) 2024 41022753

(51) Int. Cl. H04W 28/06; H04L 1/1867; H04W 8/24

(52) U.S. Cl. CPC H04W 28/065; H04L 1/188; H04W 8/24

(57) ABSTRACT

A method performed by a user equipment (UE) in a wireless communication system is provided. The method includes transmitting, to a base station, UE capability information for supporting a radio link control (RLC) receiving, from the base station, a radio resource control (RRC) message including configuration information for the RLC abandonment, and based on a discard indication for the RLC abandonment received from a protocol data convergence protocol (PDCP) layer, stopping, by an RLC layer, a transmission of at least one RLC service data unit (SDU) and corresponding segment.

### CROSS-REFERENCE TO RELATED APPLICATION(S)

This application is based on and claims priority under 35 U.S.C. § 119(a) of an Indian Provisional patent application number 202441022753, filed on Mar. 23, 2024, in the Indian Patent Office, of an Indian Provisional patent application number 202441088302, filed on Nov. 14, 2024, in the Indian Patent Office, and of an Indian Complete patent application number 202441022753, filed on Mar. 11, 2025, in the Indian Patent Office, the disclosure of each of which is incorporated by reference herein in its entirety.

### BACKGROUND

### 1. Field

The disclosure relates to wireless communication networks. More particularly, the disclosure relates to methods and systems for efficiently transmitting Extended Reality (XR) related data in wireless communication networks.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for efficient transmission for extended reality.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes transmitting, to a base station, UE capability information for supporting a radio link control (RLC) abandonment, receiving, from the base station, a radio resource control (RRC) message including configuration information for the RLC abandonment, and based on a discard indication for the RLC abandonment received from a protocol data convergence protocol (PDCP) layer, stopping, by an RLC layer, a transmission of at least one RLC service data unit (SDU) and corresponding segment.

In accordance with another aspect of the disclosure, a method performed by a base station in a wireless communication system is provided. The method includes receiving, from a user equipment (UE), UE capability information for supporting a radio link control (RLC) abandonment, and transmitting, to the UE, a radio resource control (RRC) message including configuration information for the RLC abandonment, wherein the configuration information for the RLC abandonment includes at least one of setup information, release information, modification information, enabling information, activation information, applicability information, timer information, discard confirmation indication, or triggering condition information.

In accordance with another aspect of the disclosure, a user equipment (UE) in a wireless communication system is provided. The UE includes a transceiver, and a controller coupled with the transceiver, and configured to transmit, to a base station, UE capability information for supporting a radio link control (RLC) abandonment, receive, from the base station, a radio resource control (RRC) message including configuration information for the RLC abandonment, and based on a discard indication for the RLC abandonment received from a protocol data convergence protocol (PDCP) layer, stop, by an RLC layer, a transmission of at least one RLC service data unit (SDU) and corresponding segment.

In accordance with another aspect of the disclosure, a base station in a wireless communication system is provided. The base station includes a transceiver, and a controller coupled with the transceiver, and configured to receive, from a user equipment (UE), UE capability information for supporting a radio link control (RLC) abandonment, and transmit, to the UE, a radio resource control (RRC) message including configuration information for the RLC abandonment, wherein the configuration information for the RLC abandonment includes at least one of setup information, release information, modification information, enabling information, activation information, applicability information, timer information, discard confirmation indication, or triggering condition information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts a block diagram of a system for transmitting data related to XR in a wireless communication network according to an embodiment of the disclosure;

FIG. 2 depicts an example format of a Radio Link Control (RLC) control Packet Data Unit (PDU) carrying an RLC Service Data Unit (SDU) discard information for a range based approach for 12 bit sequence number (SN) according to an embodiment of the disclosure;

FIG. 3 depicts an example format of an RLC control PDU carrying an RLC SDU discard information for a range based approach for 18 bit SN according to an embodiment of the disclosure;

FIG. 4 depicts an example format of an RLC control PDU carrying an RLC SDU discard information for a bitmap based approach with 12 bit SN according to an embodiment of the disclosure;

FIG. 5 depicts an example format of an RLC control PDU carrying an RLC SDU discard, information for a bitmap based approach with 18 bit SN, according to an embodiment of the disclosure;

FIG. 6 depicts a method for transmitting data related to an XR in a wireless communication network by a transmitting RLC entity of a UE according to an embodiment of the disclosure;

FIG. 7 depicts a method for discarding at least one RLC SDU by a transmitting of an RLC entity of a UE according to an embodiment of the disclosure;

FIG. 8 depicts a method for managing polling by a transmitting of an RLC entity according to an embodiment of the disclosure;

FIG. 9 depicts an alternate method for managing polling by a transmitting of an RLC entity, on expiry of a poll retransmit timer, according to an embodiment of the disclosure;

FIG. 10 depicts a method for an enhanced RLC transmit operation to handle RLC SDU abandonment (i.e. stopping of transmission/retransmission) and managing polling at a transmitting side of an acknowledged mode (AM) RLC entity for XR, according to an embodiment of the disclosure; and

FIG. 11 depicts an alternate method for an enhanced RLC transmit operation to handle an RLC SDU (i.e., stopping of transmission/retransmission) and managing polling at a transmitting side of an AM RLC entity for XR, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Extended Reality (XR) is an umbrella term for different realities including a Virtual Reality (VR), an Augmented Reality (AR) and a Mixed Reality (MR), and is considered as an essential technology to enable the realization of digital twin/meta universe. XR is targeted to provide a communication system framework that fulfills challenging needs of high data rate, extreme low latency, and power efficient connectivity for XR applications.

Radio Link Control (RLC) is a layer-2 sub-layer, and is involved in a number of functionalities for data plane processing of the transmitted and received packets. These functionalities include but not limited to transfer of upper layer Packet Data Units (PDUs), error correction through Automatic Repeat Request (ARQ), segmentation and reassembly of RLC Service Data Units (SDUs), re-segmentation of RLC segments, duplicate detection, RLC SDU discard, RLC reestablishment, and protocol error detection.

An SDU discard procedure at a Packet Data Convergence Protocol (PDCP) layer involves discard of the PDCP SDU when the associated timer is expired or the successful delivery of a PDCP SDU is confirmed from peer PDCP entity, for example, through a PDCP status report. When the PDCP SDU or PDU is already submitted to the RLC layer for transmission, the discard indication is given to the RLC layer.

For XR applications, the existing RLC SDU discard procedure may not be efficient and effective as the XR applications are more tightly coupled with the frame (also termed as PDU Set) transmission, and not with the IP packet transmission which is typically one-to-one mapped to the PDCP SDU and thereby, to RLC SDU. Further, the RLC SDU discard procedure could not be pursued when an RLC SDU or a segment thereof has been submitted to the lower layers (for example, Medium Access Control (MAC) layer). Accordingly, there is a need for an enhanced transmit operation to support efficient RLC SDU discard.

Thus, it is desired to address the above mentioned disadvantages or other shortcomings or at least provide a useful alternative for the RLC SDU discard procedure, and efficient transmission for XR in wireless networks.

Accordingly, there is a need in the art for solutions which will overcome the above mentioned drawback(s), among others.

The principal object of embodiments herein is to disclose methods and systems for efficiently transmitting Extended Reality (XR) related data in wireless communication networks.

Another object of embodiments herein is to disclose methods and systems for an enhanced Radio Link Control (RLC) Service Data Unit (SDU) discard procedure for XR in wireless communication networks.

Another object of embodiments herein is to disclose methods and systems for enhancing RLC transmit operations for XR, wherein the methods include a User Equipment (UE) capability signaling, a UE configuration, an RLC discard, an update of a Packet Data Convergence Protocol (PDCP) discard operation, a transmission (TX) abandonment upon discard indication, a TX abandonment upon threshold condition of retransmission (ReTX), polling enhancements for transmission abandonment, handling Acknowledgement (ACK) and Negative Acknowledgement (NACK), an update of retransmission consideration upon TX abandonment and/or receiving feedback, and Buffer Status Reporting (BSR) and Delay Status Reporting (DSR) enhancements for abandoned data.

The embodiments herein provide a method for transmitting data related to an Extended Reality (XR) in a wireless communication network by a User Equipment (UE). The method comprises indicating a UE capability information for supporting a Radio Link Control (RLC) abandonment feature to a network. The method comprises receiving a configuration of at least one configuration parameter for the RLC abandonment feature from the network in an RRC signaling message, based on the indicated UE capability information. The network configures at least one transmitting RLC entity (110) of the UE (102) with the configuration parameter. The method comprises stopping at least one RLC Service Data Unit (SDU) and corresponding segment for at least one of transmission, and retransmission through the configured transmitting RLC entity (110), upon receiving a discard indication from a Protocol Data Convergence Protocol (PDCP) layer for implementing the RLC abandonment feature in XR.

The embodiments herein provide a UE which comprises a processor, and a memory module. The processor is coupled with the memory module. The processor is configured to indicate a UE capability information for supporting an RLC abandonment feature to a network. The processor is configured to receive a configuration of at least one configuration parameter for the RLC abandonment feature from the network in an RRC signaling message, based on the indicated UE capability information. The network configures at least one transmitting RLC entity of the UE with the configuration parameter. The processor is configured to stop at least one RLC SDU and corresponding segment for at least one of transmission, and retransmission through the configured at least one transmitting RLC entity, upon receiving a discard indication from a PDCP layer for implementing the RLC abandonment feature in XR.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. The examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be, for example, physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. In an example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. In terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

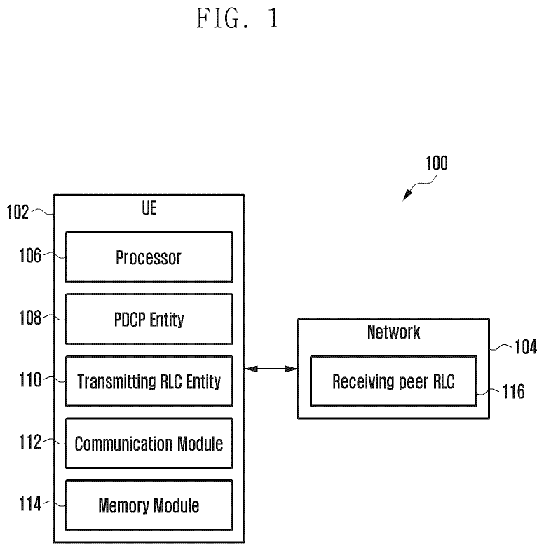

The embodiments herein achieve methods and systems for efficiently transmitting Extended Reality (XR) related data in wireless communication networks. Referring now to the drawings, and more particularly to FIGS. 1 to 11, where similar reference characters denote corresponding features consistently throughout the figures, there are shown embodiments.

Embodiments herein disclose methods for determining a Radio Link Control (RLC) Sequence Number (SN) gap when a transmitting RLC entity is indicated for an RLC SDU discard from an upper layer (for example, Packet Data Convergence Protocol (PDCP)). The methods further include triggering and sending an RLC discard information which is composed with at least one of the approach based on an RLC data Packet Data Unit (PDU) header, and the approach based on an RLC control PDU utilizing a bitmap or a range field(s) for the discarded RLC Service Data Units (SDUs). The methods also include performing one or more transmit operations upon the RLC SDU discard.

Embodiments herein further disclose an enhanced transmission operation to handle RLC SDU discard for XR in wireless communication networks, wherein a transmitter RLC entity stops or abandons the transmission or retransmission of one or more RLC SDUs that are indicated for discard by the upper layer. Further, the transmitting RLC entity discards the RLC SDU upon receiving a positive acknowledgement from a receiver entity and/or upon a stipulated time duration or a timer expiry.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 depicts a block diagram of a system 100 for transmitting data related to XR in a wireless communication network according to an embodiment of the disclosure.

The system 100 comprises a User Equipment (UE) 102, and a network 104. In an embodiment, the UE 102 acts as a transmitting device, and the network 104 acts as a receiving device. Alternatively, the transmitting device can be the network 104, and the receiving device can be the UE 102. The UE 102 further comprises a processor 106, a PDCP entity 108, a transmitting RLC entity 110, a communication module 112, and a memory module 114. The network 104 further comprises a receiving peer RLC entity 116. The transmitting RLC entity 110 can be at least one of transmitting side of an AM RLC entity or a transmitting unacknowledged mode (UM) RLC entity.

In another embodiment, the processor 106 is coupled with the PDCP entity 108, the transmitting RLC entity 110, the communication module 112, and the memory module 114. In an embodiment herein, the transmitting RLC entity 110 can be configured in the processor 106.

The transmitting RLC entity 110 can manage a UE capability signaling, a UE configuration, an RLC discard, an update of a PDCP discard operation, a transmission or retransmission abandonment upon discard indication, a transmission or retransmission abandonment upon a threshold condition of retransmission, a polling for transmission abandonment, handling an Acknowledgment (ACK) and a Negative Acknowledgment (NACK), an update of retransmission consideration upon transmission abandonment and/or receiving feedback, and Buffer Status Reporting (BSR) and Delay Status Reporting (DSR) enhancements for abandoned (i.e. stopped for transmission/retransmission) data.

In an embodiment herein, the transmitting RLC entity 110 can indicate a UE capability information for supporting an RLC abandonment feature to the network 104. The transmitting RLC entity 110 can receive a configuration of at least one configuration parameter for the RLC abandonment feature from the network 104 in an RRC signaling message, based on the indicated UE capability information. The configuration parameter comprises at least one of a setup, a release, a modification, an enable, a disable, an activation, a deactivation, an applicability, a timer, a discard confirmation indication, one or more triggers, and one or more triggering conditions. The network 104 configures, for example, the transmitting RLC entity 110 of the UE 102 with the configuration parameter for the RLC abandonment feature. In an embodiment herein, the transmitting RLC entity 110 can abandon or stop at least one RLC SDU and corresponding segment for at least one of transmission, and retransmission, upon a discard indication from a PDCP layer of the PDCP entity 108 for implementing the RLC abandonment feature in XR.

The transmitting RLC entity 110 can receive an indication from an upper layer for discarding a particular RLC SDU. The transmitting RLC entity 110 can discard the RLC SDU and corresponding segment, if the RLC SDU and corresponding segment has been submitted to one or more lower layers, on receiving the indication. In an embodiment herein, the transmitting RLC entity 110 can discard the RLC SDU and corresponding segment, if neither the RLC SDU nor the corresponding segment has been submitted to the lower layers, on receiving the indication.

In an embodiment herein, the transmitting RLC entity 110 can abandon or stop at least one of transmission, and retransmission of an Acknowledged Mode Data (AMD) Packet Data Unit (PDU) containing the RLC SDU and corresponding segment indicated for discard from an upper layer, if the RLC SDU and corresponding segment has been submitted to the lower layers. In an embodiment herein, the transmitting RLC entity 110 can abandon or stop at least one of transmission, and retransmission of the AMD PDU containing the RLC SDU and corresponding segment indicated for discard from an upper layer, if the transmitting RLC entity 110 has reached a threshold number of retransmissions, and the RLC SDU and corresponding segment has been submitted to the lower layers. In an embodiment herein, the UE 102 can be configured with the threshold number of retransmissions through the RRC signaling message. The threshold number of retransmissions can be configured for at least one of the transmitting RLC entity 110, a bearer, a Logical Channel Group (LCG), and the UE 102.

In one embodiment, the transmitting RLC entity 110 can receive a notification of a transmission opportunity by the lower layers. The transmitting RLC entity 110 can determine for each AMD PDU submitted for transmission, if both a transmission buffer and a retransmission buffer become empty after the transmission of the AMD PDU excluding one or more transmitted RLC SDUs and corresponding segments awaiting acknowledgement and excluding one or more RLC SDUs and corresponding segments for which at least one of transmission and retransmission is stopped, on receiving the notification. The transmitting RLC entity 110 can determine for each AMD PDU submitted for transmission, if no new RLC SDU can be transmitted after the transmission of the AMD PDU excluding the RLC SDUs and corresponding segments for which at least one of transmission and retransmission is stopped, on receiving the notification. In an embodiment herein, the transmitting RLC entity 110 can include a poll in the AMD PDU, if the determined at least one of both the transmission buffer and the retransmission buffer become empty after the transmission of the AMD PDU, and if no new RLC SDU can be transmitted after the transmission of the AMD PDU.

In an embodiment herein, the transmitting RLC entity 110 can detect an expiry of a poll retransmit timer (t-PollRetransmit). The transmitting RLC entity 110 can determine if both the transmission buffer and the retransmission buffer become empty excluding one or more transmitted RLC SDUs and corresponding segments awaiting acknowledgement, and excluding one or more RLC SDUs and corresponding segments for which at least one of transmission and retransmission is stopped. In an embodiment herein, the transmitting RLC entity 110 can determine if no new RLC SDU can be transmitted excluding the RLC SDUs and corresponding segments for which at least one of transmission and retransmission is stopped. The transmitting RLC entity 110 can, for example, consider at least one RLC SDU for retransmission which has a highest SN among the RLC SDUs submitted to the lower layers, and which has not been stopped for at least one of transmission and retransmission, if both the transmission buffer and the retransmission buffer become empty or if no new RLC SDU can be transmitted. In an embodiment herein, the transmitting RLC entity 110 can consider at least one RLC SDU for retransmission which has not been positively acknowledged and which has not been stopped for at least one of transmission or retransmission, if both the transmission buffer and the retransmission buffer become empty or if no new RLC SDU can be transmitted. The transmitting RLC entity 110 can include a poll in the AMD PDU, based on the considered RLC SDU.

In another embodiment herein, the transmitting RLC entity 110 can send an indication to one or more upper layers of at least one of a successful delivery, and a successful discard of at least one RLC SDU and corresponding segment, on receiving a positive acknowledgement for the RLC SDU and corresponding segment with SN=x, when at least one of transmission, and retransmission of the AMD PDU containing the RLC SDU and corresponding segment has been stopped. In an embodiment herein, the transmitting RLC entity 110 can skip to send an indication to the upper layers of at least one of the successful delivery, and the successful discard of the RLC SDU and corresponding segment, on receiving a positive acknowledgement for the RLC SDU and corresponding segment with SN=x, when at least one of transmission, and retransmission of the AMD PDU containing the RLC SDU and corresponding segment has been stopped.

The transmitting RLC entity 110 can receive a status report for the RLC SDU and corresponding segment from the receiving peer RLC entity 116 of the network 104. The transmitting RLC entity 110 can determine, if the received status report comprises one of a positive acknowledgement, and a negative acknowledgement for the RLC SDU and corresponding segment with a SN equal to a poll SN. The transmitting RLC entity 110 can stop and reset the t-PollRetransmit, if the t-PollRetransmit is running and the status report comprises one of the positive acknowledgement, and the negative acknowledgement for the RLC SDU and corresponding segment with the SN equal to the poll SN, by excluding a negative acknowledgement for the RLC SDU with the SN equal to poll SN, when at least one of transmission, and retransmission of the RLC SDU and corresponding segment has been stopped. The transmitting RLC entity 110 can send a poll and restart the t-PollRetransmit, if the t-PollRetransmit is running and the status report comprises the negative acknowledgement for the RLC SDU and corresponding segment with the SN equal to the poll SN, when at least one of transmission, and retransmission of the RLC SDU and corresponding segment has been stopped.

In another embodiment herein, the transmitting RLC entity 110 can skip considering the RLC SDU and corresponding segment as pending for at least one of transmission and retransmission, on receiving an indication from the upper layer to discard the RLC SDU. The transmitting RLC entity 110 can skip considering the RLC SDU and corresponding segment that has been stopped for at least one of transmission, and retransmission, for at least one of a Medium Access Control (MAC) BSR, and a MAC DSR. In an embodiment herein, the transmitting RLC entity 110 can skip retransmission of the RLC SDU and corresponding segment that has been negatively acknowledged, when the RLC SDU and corresponding segment has been stopped for at least one of transmission, and retransmission. In an embodiment herein, the transmitting RLC entity 110 can skip incrementing a retransmission count for the RLC SDU and corresponding segment, when the RLC SDU and corresponding segment has been stopped for at least one of transmission, and retransmission.

In an embodiment herein, the processor 106 can process and execute data of a plurality of modules of the UE 102 or the transmitting device. The processor 106 can be configured to execute instructions stored in the memory module 114. The processor 106 may comprise one or more of microprocessors, circuits, and other hardware configured for processing. The processor 106 can be, for example, at least one of a single processer, a plurality of processors, multiple homogeneous or heterogeneous cores, multiple Central Processing Units (CPUs) of different kinds, microcontrollers, special media, and other accelerators. The processor 106 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

The plurality of modules of the processor 106 of the UE 102 or the transmitting device can communicate via the communication module 112. The communication module 112 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 114 may comprise one or more volatile and non-volatile memory components which are capable of storing data and instructions of the modules of the UE 102 or the transmitting device to be executed. Examples of the memory module 114 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 114 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 114 may, in some examples, be considered a non-transitory storage medium. The term “non-transitory” may indicate that the storage medium is not embodied in a carrier wave or a propagated signal. The term “non-transitory” should not be interpreted to mean that the memory module 114 is non-movable. In certain examples, a non-transitory storage medium may store data that can, over time, change (for example, in Random Access Memory (RAM) or cache).

FIG. 1 shows example modules of the UE 102 or the transmitting device, but it is to be understood that other embodiments are not limited thereon. In other embodiments, the UE 102 or the transmitting device may include less or more number of modules. Further, the labels or names of the modules are used only for illustrative purpose and does not limit the scope of the disclosure. One or more modules can be combined together to perform same or substantially similar function in the UE 102 or the transmitting device.

When a discard indication is received from the transmitting PDCP entity 108 for a received RLC SDU, the transmitting RLC entity 110 performs the RLC SDU discard for at least one of the following cases:
a) When a received RLC SDU is in the transmission buffer and neither the RLC SDU nor a segment of the SDU has been submitted to the lower layers.
b) When a received RLC SDU is not yet assigned SN at the RLC layer.
c) When a received RLC SDU is assigned SN at the RLC layer but received RLC SDU or a segment thereof is not yet submitted to the lower layer.
d) When a received RLC SDU has been submitted to the lower layers (for example, MAC).
e) When a segment of the received RLC SDU has been submitted to the lower layers.
f) When a received RLC SDU or a segment of the received RLC SDU has been submitted to the lower layer (or transmitted) but neither yet positively acknowledged nor yet negatively acknowledged.
g) When a received RLC SDU or a segment of the received RLC SDU has been transmitted and is negatively acknowledged.
h) When a received RLC SDU or a segment of the received RLC SDU is pending for retransmission.

In an embodiment herein, upon receiving a discard indication from the PDCP entity 108 for a received RLC SDU, the transmitting RLC entity 110 may provide a confirmation to the PDCP entity 108 for discarding the RLC SDU. In an embodiment herein, a confirmation to the PDCP entity 108 for discarding the SDU is provided only when neither the RLC SDU nor a segment thereof is submitted to the lower layer (for example, MAC). In an embodiment herein, the RLC SDU and/or RLC data PDU discard may be performed by the RLC layer and a confirmation is indicated to the PDCP entity 108 irrespective of whether the RLC SDU or a segment thereof has been submitted to the lower layers or the RLC SDU or a segment thereof has not been submitted to the lower layers.

The PDCP SN gap is determined and discard signaling is triggered by the transmitting PDCP entity 108 when at least one PDCP SDU is discarded (for example, when PDU Set discard (pdu-SetDiscard) is not configured) or at least one PDU Set is discarded (for example, when PDU Set discard (pdu-SetDiscard) is configured) and at least one of the following condition is met:
a) At least one discarded PDCP SDU or at least one SDU of the discarded PDU Set was not yet submitted to associated RLC entity or entities.
b) At least one discarded PDCP SDU or at least one SDU of the discarded PDU Set was submitted to associated RLC entity or entities and neither the SDU nor a segment thereof is submitted by RLC entity to the lower layers.
c) At least one discarded PDCP SDU or at least one SDU of the discarded PDU Set was submitted to associated RLC entity or entities and the SDU or a segment thereof is submitted by RLC entity to the lower layers.
d) At least one discarded PDCP SDU or at least one SDU of the discarded PDU Set was submitted to associated RLC entity or entities, and the SDU or a segment thereof is submitted by RLC entity to the lower layers and successful reception of the SDU or pertinent RLC Data PDU(s) is acknowledged from the receiving peer RLC entity 116.
e) At least one discarded PDCP SDU or at least one SDU of the discarded PDU Set was submitted to associated RLC entity or entities.
f) At least one discarded PDCP SDU or at least one SDU of the discarded PDU Set was submitted to associated RLC entity or entities and the SDU or a segment thereof is confirmed to be discarded by the RLC entity to the PDCP entity 108.

In an embodiment herein, when a received PDCP SDU is assigned COUNT or SN at the PDCP layer of the PDCP entity 108, and the PDCP SDU is discarded and the SDU was submitted to the RLC layer, but it is confirmed by the transmitting RLC entity 110 to be discarded, the PDCP may reassign the same COUNT or PDCP SN to a new or subsequent PDCP SDU. In this case, the discard PDCP SDU is not accounted in the discard information carried in the PDCP discard signaling. In an embodiment herein, the transmitting RLC entity 110 may be at least one of primary RLC entity, other RLC entity/entities (for example, PDCP duplication) and split secondary RLC entity or entities (for example, dual connectivity).

In another embodiment herein, when PDCP duplication is activated for radio bearer, and when a received SDU is assigned COUNT or SN at the PDCP layer of the PDCP entity 108 and the PDCP SDU is discarded and the SDU was submitted to the RLC entity or entities, but confirmed by all the involved RLC entity or entities to be discarded, the PDCP may reassign the same COUNT or PDCP SN to a new or subsequent PDCP SDU. In this case, the discarded PDCP SDU is not accounted in the discard information carried in the PDCP discard signaling.

In an embodiment herein, when the discard indication is received from the transmitting PDCP entity 108 for a received RLC SDU, the transmitting RLC entity 110 performs RLC SDU discard, determines RLC SN gap, and triggers RLC discard information signaling for at least one of the following cases:
a) When a received RLC SDU has been submitted to the lower layers (e.g., MAC).
b) When a segment of the received RLC SDU has been submitted to the lower layers.
c) When a received RLC SDU or a segment of the received RLC SDU is pending for retransmission.

The transmitting RLC entity 110 (for example, a transmitting Unacknowledged Mode (UM) RLC entity or a transmitting side of an Acknowledged Mode (AM) RLC entity) determines at least one gap in the RLC SN of the RLC SDU(s) due to the received discard indication from the transmitting PDCP entity 108 (for example, when the transmitting PDCP entity 108 discards at least one PDCP SDU and/or PDU Set), and triggers an RLC discard signaling comprising of the RLC SDU discard information to be sent to the receiving peer RLC entity 116. The gap in the RLC SN is determined when at least one RLC SDU or a segment of the RLC SDU has been submitted to the lower layer (for example, MAC). When the RLC SDU is stored in the transmission buffer, and neither the RLC SDU nor a segment of the RLC SDU is submitted to the lower layer, no RLC SN gap is determined and therefore, no RLC discard signaling is triggered.

In an embodiment, a header of an RLC PDU with a SN X, carries a field comprising of at least one bit or a bitmap or a range that indicates the discard of the RLC SDUs or segment thereof which are immediately preceding to the SN X. The bit or bitmap or range field for the discard information may be mapped to at least one reserved bit available in the header of the RLC PDU or at least a new bit is allocated in the header of the RLC PDU. In an embodiment herein, the RLC PDU with SN X may not carry any payload (for example, application data or PDCP SDU). That is, zero data header only RLC PDU is sent. In an embodiment herein, the RLC PDU with SN X may carry the payload (for example, application data or PDCP SDU).

In another embodiment, the header of the RLC PDU with SN X, carries a field comprising of at least one bit or a bitmap or a range that indicates the discard of the RLC SDU or segment thereof which is having SN X. The bit or bitmap or a range field for the discard information may be mapped to at least one reserved bit available in the header of the RLC PDU or at least a new bit is allocated in the header of the RLC PDU. Further, the RLC PDU may not carry any payload (for example, application data or PDCP SDU). That is, zero data header only RLC PDU is sent.

In an embodiment herein, an RLC discard signaling comprising of the RLC discard information is carried in at least one field in the header of the RLC Data PDU. At least one field in the header may comprise of the number of consecutive RLC SDUs that are discarded and having SN earlier than the SN of the RLC SDU that carries the field in the header of the RLC Data PDU, and/or the first discarded RLC SDU SN. In an embodiment herein, the RLC Data PDU (or corresponding RLC SDU) that carries at least one field in the RLC header may be discarded, then the next un-discarded RLC data PDU may carry at least one field in the RLC header that comprises the RLC discard information for the discard SDU. The RLC Data PDU may not comprise of data (i.e., application payload or RLC SDU) when it is carrying the discard information in the header and when data to carry is not available i.e., header only RLC data PDU is constructed in order to carry the RLC discard signaling. The header only RLC data PDU is assigned an SN of the next RLC SDU to be transmitted.

In an embodiment herein, the RLC discard signaling comprising of the RLC discard information is carried in a RLC control PDU (for example, may be termed as “Discard Info PDU”). The RLC control PDU carrying the RLC discard signaling is identified by a Control PDU Type (CPT) field set to a specific value (for example, value 001 can be assigned to Control PDU Type field for “Discard Info PDU”). The control PDU carries a D/C field and set to value 0 to indicate that it is a control PDU.

The RLC discard signaling comprising of the RLC discard information includes at least one discarded RLC SDU and/or RLC Data PDU SN.

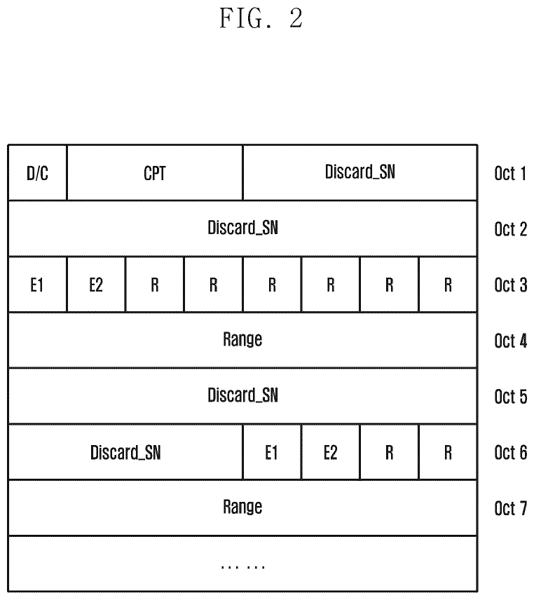

FIG. 2 depicts an example format of a Radio Link Control (RLC) control Packet Data Unit (PDU) carrying an RLC Service Data Unit (SDU) discard information for a range based approach for 12 bit SN according to an embodiment of the disclosure.

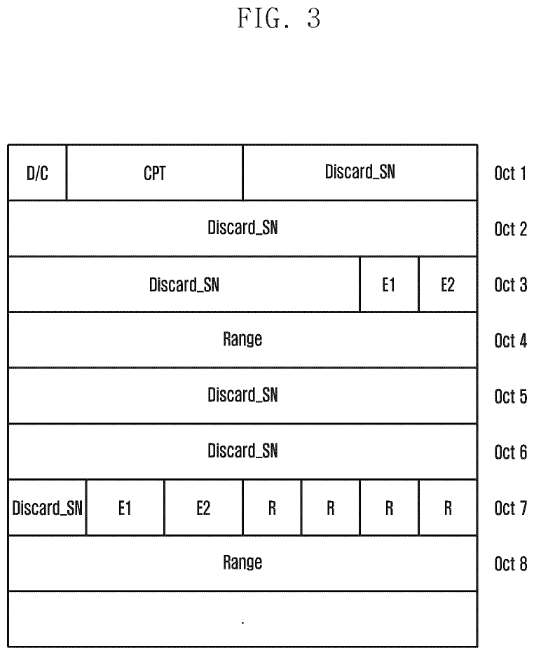

FIG. 3 depicts an example format of an RLC control PDU carrying an RLC SDU discard information for the range based approach for 18 bit SN according to an embodiment of the disclosure.

In an embodiment herein, the RLC discard signaling comprising of the RLC discard information includes at least one “set” of first discarded RLC SDU SN (for example, termed as Discard_SN), and a range of contiguous RLC SDU(s) (i.e., sequentially ordered RLC SDU(s)) that are discarded. For example, in a set, the range may be a field or a value or a number that indicates the number of sequentially ordered (or contiguous) SDUs from the first discarded RLC SDU SN that are discarded. Range may or may not include the first discarded RLC SDU. This is illustrated in FIG. 2 (for 12 bit SN), and FIG. 3 (for 18 bit SN). E1 indicates whether or not another Discard_SN field follows. For example, E2 indicates whether or not range field follows the Discard_SN field. R indicates a reserved bit. In an embodiment herein, the order, size, placement, presence, and absence of one or more fields in the RLC control PDU may be altered.

In an embodiment herein, when only one RLC SDU is discarded, it is indicated by Discard_SN field and range field may be omitted in the RLC control PDU.

In an embodiment herein, at least one set of discard information in the discard signaling (for example, RLC control PDU) may pertain to the discarded RLC SDUs caused due to discard indication from PDCP resulting from a discard timer expiry and/or discard timer low importance expiry at PDCP.

In another embodiment, two or more sets of discard information included in the discard signaling (for example, RLC control PDU) may be non-contiguous to each other.

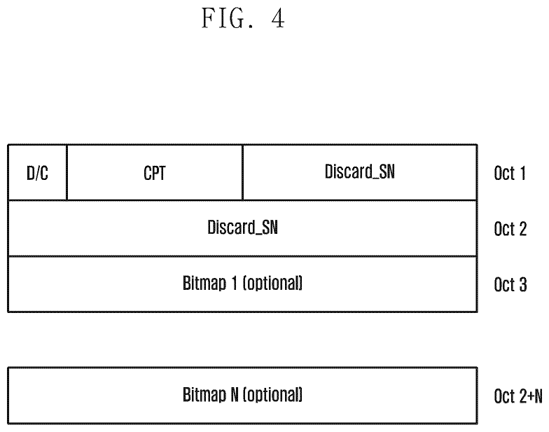

FIG. 4 depicts an example format of an RLC control PDU carrying an RLC SDU discard information for a bitmap based approach with 12 bit SN according to an embodiment of the disclosure.

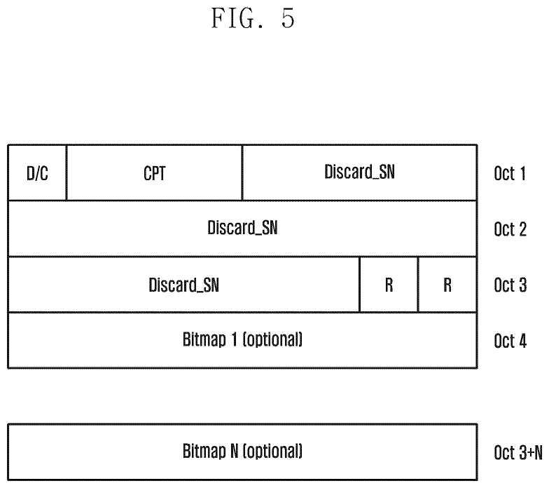

FIG. 5 depicts an example format of an RLC control PDU carrying an RLC SDU discard, information for the bitmap based approach with 18 bit SN, according to an embodiment of the disclosure.

In an embodiment herein, the RLC discard signaling comprising of the discard information (for example, RLC control PDU) includes at least one of a first discarded RLC SDU SN (for example, termed as Discard_SN), and a bitmap of contiguous RLC SDU(s) (i.e., sequentially ordered RLC SDU(s)) wherein bitmap indicates either the RLC SDU is discarded (for example, corresponding ordered bit in the bitmap is set to 1) or the RLC SDU is not discarded (for example, corresponding ordered bit in the bitmap is set to 0). For example, the first bit in the bitmap may refer to the RLC SDU which has the next SN to the first discarded RLC SDU SN included in the discard information. In an embodiment herein, the bitmap is octet aligned (multiple of 8 bits) and the last bit in the bitmap may not correspond to the last discarded RLC SDU SN. The bits in the bitmap after the last bit, which is set to 1 (i.e., RLC SDU SN is discarded), may be interpreted by receiver as “do not care” i.e., the receiving peer RLC entity 116 may not determine any discard status for the RLC SDUs with corresponding SNs. This is illustrated in FIG. 4 (for 12 bit SN), and FIG. 5 (for 18 bit SN). E1 indicates whether or not another Discard_SN field follows. E2 indicates whether or not Range field follows the Discard_SN field. R indicates reserved bit. In an embodiment herein, the order, size, placement, presence, and absence for one or more fields in the RLC control PDU may be altered.

In an embodiment herein, when only one RLC SDU or segment of the RLC SDU is discarded, it is indicated by Discard_SN field and bitmap field may be omitted in the RLC control PDU.

When an RLC entity is configured by the upper layers to send an RLC entity discard information (for example, RLCdiscardInfoRequired is configured), the transmitting RLC entity 110 may trigger an RLC discard signaling to send a discard information when a RLC SN gap is determined. The RLC SN gap may be determined when an RLC SDU or a segment of the RLC SDU which has an assigned SN value is indicated for discard from PDCP and/or a RLC SDU or a segment of RLC SDU which has been submitted by RLC to the lower layers is indicated for discard from PDCP.

In another embodiment, when an RLC entity is configured by the upper layers to send an RLC entity discard information (for example, RLCdiscardInfoRequired is configured), the transmitting RLC entity 110 may trigger an RLC discard signaling to send discard information when the upper layer requests an RLC entity re-establishment.

In an embodiment herein, an example specification for the transmit operation of the RLC discard signaling is provided as follows:

### EXAMPLE 1

For transmitting UM RLC entity or transmitting side of AM RLC entity configured by the upper layers to send an RLC discard information (RLCdiscardInfoRequired is configured), the transmitting UM RLC entity or transmitting side of AM RLC entity shall determine an RLC SN gap, and trigger an RLC discard signaling to send discard information when:
an RLC SDU or a segment of RLC SDU which has an assigned SN value is indicated for discard from PDCP; and/or
a RLC SDU or a segment of RLC SDU which has been submitted by RLC to the lower layers is indicated for discard from PDCP.

The transmitting UM RLC entity or transmitting side of AM RLC entity is configured with a prohibit timer (t-DiscardInfoProhibit). The prohibit timer controls the transmission of the RLC discard signaling, and prevents excessive and frequent sending of the RLC discard information. t-DiscardInfoProhibit may be configured per RLC entity or per radio bearer or per UE basis in an RRC signaling message.

In an embodiment, an example specification for the transmit operation of the RLC discard signaling is provided as follows:

### EXAMPLE 2

When an RLC discard Information reporting has been triggered, the transmitting side of an AM RLC entity shall:
if t-DiscardInfoProhibit is not running:
   at the first transmission opportunity indicated by lower layer, construct a discard Info PDU and submit it to lower layer.
else:
   at the first transmission opportunity indicated by lower layer after t-DiscardInfoProhibit expires, construct a single discard Info PDU even if discard Information reporting was triggered several times while t-Discard InfoProhibit was running and submit it to lower layer.

When an abandonment Info PDU has been submitted to lower layer, the receiving side of AM RLC entity shall:
start t-DiscardInfoProhibit.

In an embodiment herein, an example specification for the transmit operation of the RLC discard signaling with range based approach is provided as follows (as depicted in FIGS. 2 and 3).

### EXAMPLE 3

When constructing a discard Info PDU, the transmitting side of AM RLC entity shall:
for the RLC SDUs with SN such that TX_Next_Ack<=SN<TX_Next_Ack+AM_Window_Size that has been indicated for discard by the PDCP, in increasing SN order of RLC SDUs and increasing byte segment order within RLC SDUs that have been submitted to lower layer and have not been acknowledged by receiving side of RLC entity, starting with SN=TX_Next_Ack up to the point where the resulting RLC Control PDU still fits to the total size of RLC PDU(s) indicated by lower layer:
for an RLC SDU for which is indicated for discard by PDCP:
   include in the Discard Info PDU a Discard_SN which is set to the SN of the RLC SDU.
for each of the continuous sequences of RLC SDUs that have been indicated for discard by PDCP:
   include in the Discard Info PDU a set of Discard_SN and discarded SDU SN range;

In an embodiment herein, an example specification for the transmit operation of the RLC discard signaling with bitmap based approach is provided as follows (as depicted in FIGS. 4 and 5).

### EXAMPLE 4

When constructing a Discard Info PDU, the transmitting side of AM RLC entity shall:
for the RLC SDUs with SN such that TX_Next_Ack<=SN<TX_Next_Ack+AM_Window_Size that has been indicated for discard by the PDCP, in increasing SN order of RLC SDUs and increasing byte segment order within RLC SDUs that have been submitted to lower layer and have not been acknowledged by receiving side of RLC entity, starting with SN=TX_Next_Ack up to the point where the resulting RLC Control PDU still fits to the total size of RLC PDU(s) indicated by lower layer:
for the first RLC SDU which is indicated for discard by PDCP:
   include in the Discard Info PDU a Discard_SN which is set to the SN of the RLC SDU.
for a continuous sequence of RLC SDUs>Discard_SN:
   include in the Discard Info PDU a bitmap;
   setting in the bitmap field as ‘0’ for all RLC SDUs that have not been indicated for discard by PDCP;
   setting in the bitmap field as ‘1’ for all RLC SDUs that have been indicated for discard by PDCP;

In an embodiment herein, the transmitting UM RLC entity or the transmitting side of AM RLC entity may not repeat previously transmitted RLC discard information partially or completely in a subsequently transmitted RLC discard information. That is discard information of a specific SDU can be transmitted only once.

The transmitting UM RLC entity or the transmitting side of AM RLC entity may repeat previously transmitted discard information partially or completely in a subsequently transmitted discard information. That is discard information of a specific SDU can be transmitted more than once.

In another embodiment, the transmitting UM RLC entity or the transmitting side of AM RLC entity performs discard information signaling in at least one of congestion scenario (for example, when Perceived Signal Quality (PSI) based SDU discard is activated) and non-congestion scenario (for example, when PSI based SDU discard is deactivated). This may be configured in the RRC signaling or specified in the specification or left to implementation for the discard information managing approach.

In an embodiment herein, the transmitting RLC entity 110 is configured to send the RLC discard information to the receiving peer RLC entity 116 with one of an RLC control PDU based on range based approach, and an RLC control PDU based on bitmap based approach. The configuration parameter may be configured per RLC entity or per DRB or per QoS flow or per UE in an RRC signaling message.

In an embodiment herein, the choice for sending the RLC discard information with one of the RLC control PDU based on range based approach, and the RLC control PDU based on bitmap based approach is left to UE implementation.

Sending RLC discard information with one of the RLC control PDU based on range based approach, and the RLC control PDU based on bitmap based approach is pre-specified (for example, it is specified in the 3GPP standards specification).

In an embodiment herein, the UE 102 indicates its capability to support enhanced RLC abandonment feature and/or RLC abandonment signaling feature in a UE capability message and/or through an indication in a UE Assistance Information (UAI) message to the network 104. The enhanced RLC abandonment feature is the ability of the UE 102 to discard the RLC SDU or a segment thereof even when the RLC SDU or a segment has already been submitted to the lower layers.

In an embodiment, the UE's capability to support the enhanced RLC abandonment feature and/or RLC abandonment signaling feature is at least one of optional capability without signaling, optional capability with signaling, and mandatory capability.

In another embodiment, the UE's capability to support the enhanced RLC abandonment feature and/or RLC abandonment signaling feature is implicitly or explicitly linked with the UE's capability to support Release 19 XR feature.

In an embodiment herein, the UE 102 indicates its capability to support the enhanced RLC abandonment feature and/or RLC abandonment signaling feature as independent and separate from its capability to support enhanced a PDCP discard feature and/or PDCP discard signaling.

In an embodiment herein, the UE 102 indicates its capability to support the enhanced RLC abandonment feature and/or RLC abandonment signaling feature commonly along with its capability to support enhanced PDCP discard feature and/or PDCP discard signaling. In another embodiment, the UE 102 indicates a common capability or a common parameter for support of both PDCP and RLC features. In an embodiment herein, for Release 19 for 3GPP specification, support of enhanced PDCP discard feature and/or PDCP discard signaling feature also implies that the UE 102 supports the enhanced RLC abandonment feature and/or RLC abandonment signaling feature.

The UE 102 receives the configuration for the enhanced RLC discard parameter from the network 104 in an RRC signaling message (for example, RRC reconfiguration message). The configuration may comprise of at least one configuration parameter that may include, but not limited to, at least one of a setup, a release, a modification, enabling, disabling, an activation, a deactivation, an applicability prohibit timer, a discard confirmation indication required, one or more triggers, and one or more triggering conditions. For example, the configuration parameter may include a configuration parameter “EnhancedRLCdiscardApplied” to configure or indicate the transmitting RLC entity 110 to apply the enhanced RLC discard feature. The configuration may be configured per UE or per radio bearer or per RLC entity, and may be included in the rlc-Config for the radio bearer configuration in the RRC reconfiguration.

In an embodiment herein, the transmitting RLC entity 110 may be configured with at least one configuration parameter that controls whether the RLC entity is allowed to discard the RLC SDU or a segment thereof that has been submitted to the lower layers.

In an embodiment herein, the transmitting RLC entity 110 may be configured with at least one configuration parameter that controls whether the RLC entity informs RLC SN gap to the receiving peer RLC entity 116.

When indicated from the upper layer (for example, PDCP) to discard a particular RLC SDU, the transmitting side of AM RLC entity or the transmitting UM RLC entity shall discard the indicated RLC SDU, if neither the RLC SDU nor a segment thereof has been submitted to the lower layers, except when the transmitting side of an AM RLC entity or the transmitting UM RLC entity is configured to allow discarding RLC SDU or a segment thereof that has been submitted to the lower layers. The transmitting side of an AM RLC entity shall not introduce an RLC SN gap when discarding an RLC SDU, except when the transmitting side of an AM RLC entity is configured to inform RLC SN gap to the receiving side of peer AM RLC entity.

### EXAMPLE 5

### 5.X SDU Discard Procedures

When indicated from the upper layer (for example, PDCP) to discard a particular RLC SDU, the transmitting side of an AM RLC entity or the transmitting UM RLC entity shall discard the indicated RLC SDU, if neither the RLC SDU nor a segment thereof has been submitted to the lower layers, except when the transmitting side of an AM RLC entity or the transmitting UM RLC entity is configured to allow discarding RLC SDU or a segment thereof that has been submitted to the lower layers. The transmitting side of an AM RLC entity shall not introduce an RLC SN gap when discarding an RLC SDU, except when the transmitting side of an AM RLC entity is configured to inform RLC SN gap to the receiving side of peer AM RLC entity.

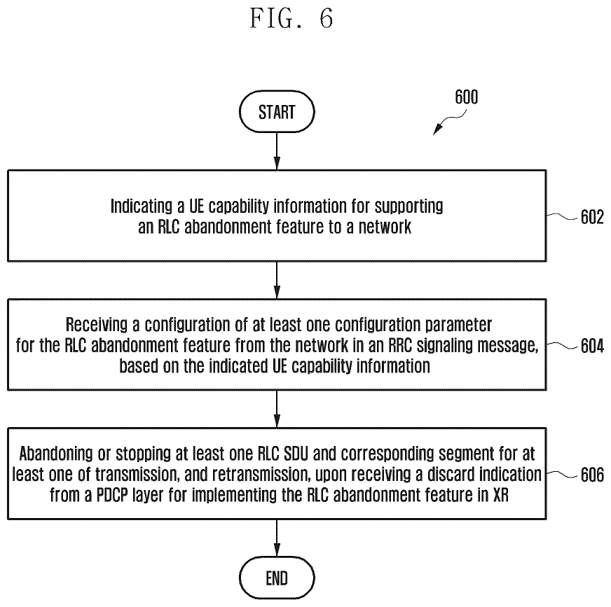

FIG. 6 depicts a method 600 for transmitting data related to an XR in a wireless communication network by the transmitting RLC entity 110 of the UE 102 according to an embodiment of the disclosure.

The method 600 comprises indicating a UE capability information for supporting an RLC abandonment feature to the network 104, as depicted in operation 602. The method 600 comprises receiving a configuration of at least one configuration parameter for the RLC abandonment feature from the network 104 in an RRC signaling message, based on the indicated UE capability information, as depicted in operation 604. The network 104 configures the transmitting RLC entity 110 of the UE 102 with the configuration parameter.

Thereafter, the method 600 comprises abandoning or stopping at least one RLC SDU and corresponding segment for at least one of transmission, and retransmission, as depicted in operation 606, upon receiving a discard indication from the PDCP layer of the PDCP entity 108 for implementing the RLC abandonment feature in XR.

The various actions in method 600 may be performed in the order presented, in a different order or simultaneously. Further, in some embodiments, some actions listed in FIG. 6 may be omitted.

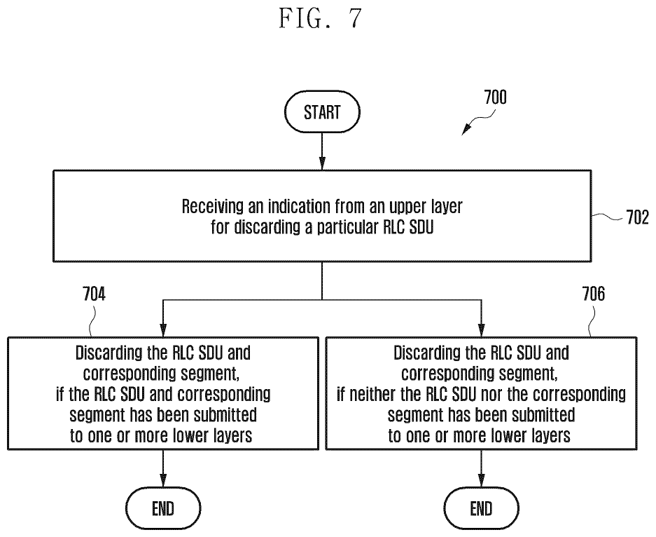

FIG. 7 depicts a method 700 for discarding at least one RLC SDU by the transmitting RLC entity 110 of the UE 102 according to an embodiment of the disclosure.

The method 700 comprises receiving a discard indication from an upper layer (PDCP layer of the PDCP entity 108) for discarding a particular RLC SDU, as depicted in operation 702. Thereafter, the method 700 comprises discarding the RLC SDU and corresponding segment, if the RLC SDU and corresponding segment has been submitted to one or more lower layers, as depicted in operation 704, on receiving the discard indication. Alternatively, the method 700 comprises discarding the RLC SDU and corresponding segment, if neither the RLC SDU nor the corresponding segment has been submitted to the lower layers, on receiving the discard indication, as depicted in operation 706.

The various actions in method 700 may be performed in the order presented, in a different order or simultaneously. Further, in some embodiments, some actions listed in FIG. 7 may be omitted.

In an embodiment herein, an example specification for the transmit operation of the PDCP discard signaling is provided as follows:

### EXAMPLE 6

For DRBs configured by the upper layers to send a PDCP discard information (discardInformationRequired is configured), the transmitting PDCP entity 108 shall determine a PDCP SN gap, and trigger a PDCP discard signaling to send discard information when at least one of the conditions are met:
a PDCP SDU (including SDU belonging to PDU Set) which has an assigned COUNT value is discarded.
a PDCP SDU is discarded but was not yet submitted to RLC or if submitted to RLC, neither the SDU nor a segment thereof has been submitted by RLC to the lower layers
an Enhanced RLC discard parameter is configured and PDCP SDU is discarded and was submitted to RLC.
a confirmation for the discard is received from the RLC for the PDCP SDU submitted to RLC.

In an embodiment herein, the transmitting RLC entity 110 performs the enhanced discard operation in at least one of congestion scenario (for example, when PSI based SDU discard is activated) and non-congestion scenario (for example, when PSI based SDU discard is deactivated). This may be configured in the RRC signaling or specified in the specification or left to UE/Network implementation for the discard approach.

The enhanced discard RLC operation is applied to at least one of a Master Cell Group (MCG) bearer, a Secondary Cell Group (SCG) bearer, a split bearer, a bearer with PDCP duplication activated, and Dual Active Protocol Stack (DAPS) bearer. This may be configured in the RRC signaling or specified in the specification or left to UE/Network implementation for the discard approach.

In an embodiment, the transmitting UM RLC entity may discard the indicated RLC SDU by the PDCP entity 108 if at least one of the RLC SDU has been submitted to the lower layers and a segment of the RLC SDU has been submitted to the lower layers.

In another embodiment, the transmitting side of AM RLC entity may discard the indicated RLC SDU by the PDCP entity 108 if at least one of the RLC SDU has been submitted to the lower layers and a segment of the RLC SDU has been submitted to the lower layers.

In an embodiment herein, the transmitting side of an AM RLC entity stops (or abandons) the transmission RLC SDU for which the RLC entity is indicated from the upper layer (for example, PDCP) to discard the RLC SDU, and if the RLC SDU or at least one segment thereof has been submitted to the lower layers.

The transmitting side of an AM RLC entity stops (or abandons) the transmission and/or retransmission of AMD PDU containing the RLC SDU or RLC SDU segments for which the RLC entity is indicated from the upper layer (for example, PDCP) to discard the RLC SDU, and if the RLC SDU or at least one segment thereof has been submitted to the lower layers.

In an embodiment herein, the transmitting side of an AM RLC entity stops (or abandons) the transmission and/or retransmission of AMD PDU containing RLC SDU or RLC SDU segments for which the RLC entity has reached a configured threshold number of retransmissions and if the RLC SDU or at least one segment thereof has been submitted to the lower layers. The UE 102 can be configured with the threshold number of retransmissions through an RRC signaling message (for example, an RRC Reconfiguration message). The configuration may be for a specific RLC entity or for a specific bearer or for a specific LCG or commonly for the UE 102.

The transmitting UM RLC entity stops (or abandons) the transmission of RLC SDU(s) for which the RLC entity is indicated from the upper layer (for example, PDCP) to discard the RLC SDU(s), and if the RLC SDU or at least one segment thereof has been submitted to the lower layers.

In an embodiment herein, the transmitting UM RLC entity discards the RLC SDU(s) for which the RLC entity is indicated from the upper layer (for example, PDCP) to discard the RLC SDU(s), irrespective of whether the RLC SDU or at least one segment thereof has been submitted or not submitted to the lower layers.

In an embodiment herein, the transmitting UM RLC entity stops (or abandons) the transmission of UMD PDU containing RLC SDU or RLC SDU segments for which the RLC entity is indicated from the upper layer (for example, PDCP) to discard the RLC SDU(s) and if the RLC SDU or at least one segment thereof has been submitted to the lower layers.

In another embodiment, the transmitting side of AM RLC entity triggers a poll when the RLC entity stops (or abandons) the transmission or retransmission of RLC SDU.

In an embodiment herein, the transmitting side of AM RLC entity triggers a poll when the RLC entity stops (or abandons) the transmission or retransmission of AMD RLC PDU.

Upon notification of a transmission opportunity by the lower layer, for each AMD PDU submitted for transmission, the transmitting side of an AM RLC entity includes a poll in the AMD PDU, if both the transmission buffer and the retransmission buffer becomes empty (excluding transmitted RLC SDUs or RLC SDU segments awaiting acknowledgements and/or excluding RLC SDUs or RLC SDU segments for which transmission or retransmission is stopped or abandoned) after the transmission of the AMD PDU, or if no new RLC SDU can be transmitted after the transmission of the AMD PDU (for example, due to window stalling or transmission or retransmission is stopped or abandoned for RLC SDUs or RLC SDU segments).

In an embodiment herein, a few examples of proposed specification for the transmit operation of the RLC polling is provided as follows:

### EXAMPLE 7

Upon notification of a transmission opportunity by the lower layer, for each AMD PDU submitted for transmission, the transmitting side of an AM RLC entity shall:
if both the transmission buffer and the retransmission buffer become empty (excluding transmitted RLC SDUs or RLC SDU segments awaiting acknowledgements and/or excluding RLC SDUs or RLC SDU segments for which transmission or retransmission is stopped or abandoned) after the transmission of the AMD PDU; or
if no new RLC SDU can be transmitted after the transmission of the AMD PDU (for example, due to window stalling or transmission or retransmission is stopped or abandoned for RLC SDUs or RLC SDU segments);
include a poll in the AMD PDU as described below.

### EXAMPLE 8

Upon expiry of t-PollRetransmit, the transmitting side of an AM RLC entity shall:
if both the transmission buffer and the retransmission buffer are empty (excluding transmitted RLC SDU or RLC SDU segment awaiting acknowledgements); or
if no new RLC SDU or RLC SDU segment can be transmitted (for example, due to window stalling):
   consider the RLC SDU with the highest SN among the RLC SDUs submitted to the lower layer for retransmission; or
   consider any RLC SDU which has not been positively acknowledged for retransmission and which has not been stopped or abandoned for transmission or retransmission.
include a poll in an AMD PDU as described in clause 5.3.3.2.

### EXAMPLE 9

Upon expiry of t-PollRetransmit, the transmitting side of an AM RLC entity shall:
if both the transmission buffer and the retransmission buffer are empty (excluding transmitted RLC SDU or RLC SDU segment awaiting acknowledgements and/or excluding RLC SDUs or RLC SDU segments for which transmission or retransmission is stopped or abandoned); or
if no new RLC SDU or RLC SDU segment can be transmitted (for example, due to window stalling or transmission or retransmission is stopped or abandoned for RLC SDUs or RLC SDU segments):
   consider the RLC SDU with the highest SN among the RLC SDUs submitted to lower layer for retransmission; or
   consider any RLC SDU which has not been positively acknowledged for retransmission and which has not been stopped or abandoned for transmission or retransmission.
include a poll in an AMD PDU as described in clause 5.3.3.2.

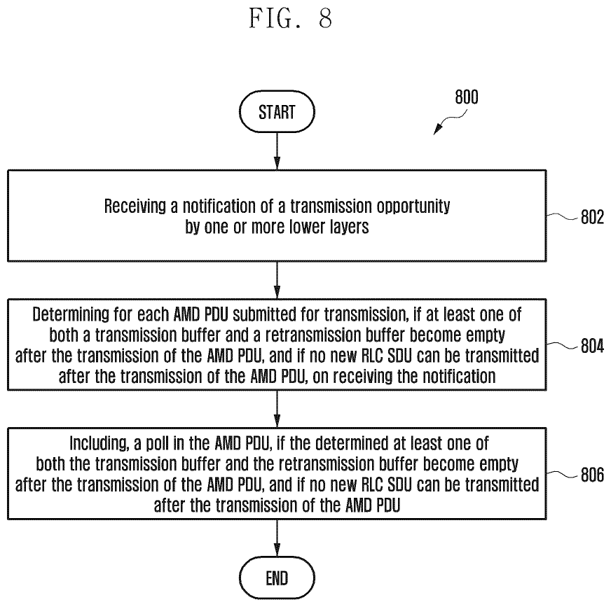

FIG. 8 depicts a method 800 for managing polling by the transmitting RLC entity 110 according to an embodiment of the disclosure.

The method 800 comprises receiving a notification of a transmission opportunity by one or more lower layers, as depicted in operation 802. The method 800 comprises determining for each AMD PDU submitted for transmission, if at least one of both a transmission buffer and a retransmission buffer become empty after the transmission of the AMD PDU excluding one or more transmitted RLC SDUs and corresponding segments awaiting acknowledgement and excluding one or more RLC SDUs and corresponding segments for which at least one of transmission and retransmission is stopped, and if no new RLC SDU can be transmitted after the transmission of the AMD PDU excluding one or more RLC SDUs and corresponding segments for which at least one of transmission and retransmission is stopped, as depicted in operation 804, on receiving the notification.

Thereafter, the method 800 comprises including a poll in the AMD PDU, as depicted in operation 806, if the determined at least one of both the transmission buffer and the retransmission buffer become empty after the transmission of the AMD PDU, and if no new RLC SDU can be transmitted after the transmission of the AMD PDU.

The various actions in method 800 may be performed in the order presented, in a different order or simultaneously. Further, in some embodiments, some actions listed in FIG. 8 may be omitted.

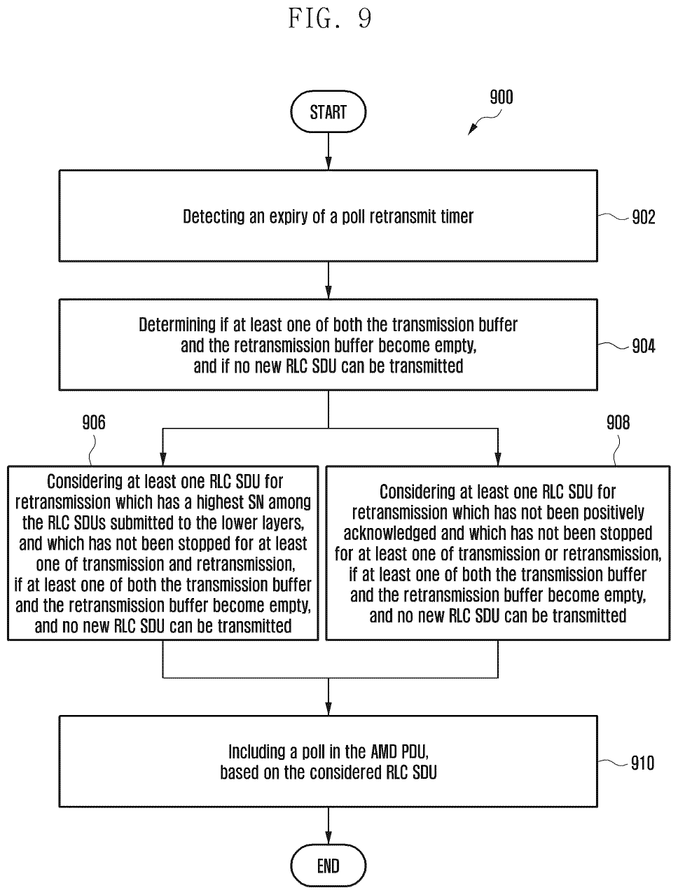

FIG. 9 depicts an alternate method 900 for managing polling by the transmitting RLC entity 110, on expiry of a poll retransmit timer according to an embodiment of the disclosure.

The method 900 comprises detecting an expiry of a poll retransmit timer, as depicted in operation 902. The method 900 comprises determining if at least one of both the transmission buffer and the retransmission buffer become empty excluding one or more transmitted RLC SDUs and corresponding segments awaiting acknowledgement and excluding one or more RLC SDUs and corresponding segments for which at least one of transmission and retransmission is stopped, and if no new RLC SDU can be transmitted excluding one or more RLC SDUs and corresponding segments for which at least one of transmission and retransmission is stopped, as depicted in operation 904.

The method 900 comprises considering at least one RLC SDU for retransmission which has a highest SN among the RLC SDUs submitted to the lower layers, and which has not been stopped for at least one of transmission and retransmission, if at least one of both the transmission buffer and the retransmission buffer become empty, and no new RLC SDU can be transmitted, as depicted in operation 906.

Alternately, the method 900 comprises considering at least one RLC SDU for retransmission which has not been positively acknowledged and which has not been stopped for at least one of transmission or retransmission, if at least one of both the transmission buffer and the retransmission buffer become empty, and no new RLC SDU can be transmitted, as depicted in operation 908. Thereafter, the method 900 comprises including a poll in the AMD PDU, based on the considered RLC SDU, as depicted in operation 910.

The various actions in method 900 may be performed in the order presented, in a different order or simultaneously. Further, in some embodiments, some actions listed in FIG. 9 may be omitted.

In an embodiment herein, upon reception of a status report from the receiving RLC AM entity, the transmitting side of an AM RLC entity determines if the status report comprises a positive or negative acknowledgement for the RLC SDU with an SN equal to POLL_SN (excluding negative acknowledgement for the RLC SDU for which transmission or retransmission has been stopped or abandoned). If t-PollRetransmit is running and the STATUS report comprises a positive or negative acknowledgement for the RLC SDU with an SN equal to POLL_SN (excluding negative acknowledgement for the RLC SDU with a sequence number equal to POLL_SN for which transmission or retransmission has been stopped or abandoned), then the transmitting side of an AM RLC entity stops and resets t-PollRetransmit.

### EXAMPLE 10

Upon reception of the status report from the receiving RLC AM entity the transmitting side of AM RLC entity shall:
if the STATUS report comprises a positive or negative acknowledgement for the RLC SDU with sequence number equal to POLL_SN (excluding negative acknowledgement for the RLC SDU for which transmission or retransmission is stopped or abandoned):
   if t-PollRetransmit is running:
      stop and reset t-PollRetransmit.

In an embodiment herein, upon reception of a status report from the receiving RLC AM entity, the transmitting side of an AM RLC entity determines if the status report comprises a negative acknowledgement for the RLC SDU with sequence number equal to POLL_SN and for which transmission or retransmission is stopped or abandoned. If t-PollRetransmit is running, and if the status report comprises a negative acknowledgement for the RLC SDU with a sequence number equal to POLL_SN and for which transmission or retransmission has been stopped or abandoned, then the transmitting side of an AM RLC entity sends a poll and restarts t-PollRetransmit.

### EXAMPLE 11

Upon reception of a STATUS report from the receiving RLC AM entity the transmitting side of an AM RLC entity shall:
if the STATUS report comprises a negative acknowledgement for the RLC SDU with sequence number equal to POLL_SN and for which transmission or retransmission is stopped or abandoned:
   if t-PollRetransmit is running:
      sends a poll and restarts t-PollRetransmit.

In an embodiment, upon reception of a status report from the receiving RLC AM entity, the transmitting side of an AM RLC entity determines if the status report comprises a negative acknowledgement for the RLC SDU with an SN equal to POLL_SN and for which transmission or retransmission is stopped or abandoned. If the status report comprises a negative acknowledgement for the RLC SDU with an SN equal to POLL_SN and for which transmission or retransmission has been stopped or abandoned, then the transmitting side of an AM RLC entity sends a poll and starts/restarts t-PollRetransmit.

### EXAMPLE 12

Upon reception of a STATUS report from the receiving RLC AM entity the transmitting side of an AM RLC entity shall:
if the STATUS report comprises a negative acknowledgement for the RLC SDU with a sequence number equal to POLL_SN and for which transmission or retransmission has been stopped or abandoned:
   sends a poll and starts/restarts t-PollRetransmit.

In another embodiment herein, the transmitting side of an AM RLC entity discards the AMD PDU containing RLC SDU(s) or RLC SDU segments and/or discards corresponding RLC SDUs, for which transmission and/or retransmission of AMD PDU was previously stopped (or abandoned), when the RLC entity receives a status report comprising of an acknowledgement (ACK) for the AMD PDU(s). In an embodiment herein, if a negative acknowledgement (NACK) is received for this AMD PDU(s), then the transmitter RLC entity 110 ignores or disregards the NACK and does not perform retransmission. Further, the RLC entity may wait for the ACK for this AMD PDU before discarding the AMD PDU and/or corresponding RLC SDU. In an embodiment herein, if a negative acknowledgement (NACK) is received for this AMD PDU(s), then the transmitter RLC entity 110 sends a poll to the receiver RLC entity and enquires latest status. In an embodiment herein, if a negative acknowledgement (NACK) is received for this AMD PDU(s), then the transmitter RLC entity 110 waits for a stipulated or configured time duration (for example, running a timer or a counter and upon its expiry) and discards the AMD PDU and/or corresponding of no acknowledgement is received until timer expiry or upon receiving a positive acknowledgement.

The transmitting side of an AM RLC entity discards the AMD PDU containing RLC SDU(s) or RLC SDU segments and/or discards corresponding RLC SDUs, for which transmission and/or retransmission of AMD PDUs was previously stopped (or abandoned), when a local timer or a configured timer (for example, timer may be termed as “discard_wait_timer1”) has expired. In an embodiment herein, the discard_wait_timer1 is started/restarted when the transmission and/or retransmission of AMD PDU was previously stopped. In an embodiment herein, a variable “discard_wait_sn” is set to the Sequence Number (SN)=x, when the transmission and/or retransmission of AMD PDU was previously stopped, wherein x is the SN of RLC SDU for which the transmission or retransmission of the AMD PDU(s) containing the RLC SDU or SDU segment was stopped or abandoned. The UE 102 can be configured with discard_wait_timer1 and/or discard_wait_sn parameters through a RRC signaling message (for example, a RRC Reconfiguration message). The configuration may be for a specific RLC entity, or for a specific bearer, or for the specific LCG or commonly for the UE 102.

In an embodiment herein, the UE 102 indicates its capability or support of the feature for stopping or abandoning the transmission of the RLC packet (or enhanced RLC operation for XR) to the network 104, and accordingly, the network 104 may configure the UE 102. The UE 102 may indicate the support of this feature in at least one of a UE capability information message, and a UE assistance information message.

In another embodiment, when receiving a positive acknowledgement for an RLC SDU with SN=x, for which the transmission or retransmission of the AMD PDU(s) containing the RLC SDU or SDU segment was stopped or abandoned, the transmitting side of an AM RLC entity sends an indication to the upper layers of successful delivery of the RLC SDU.

In an embodiment, when receiving a positive acknowledgement for an RLC SDU with SN=x, for which the transmission or retransmission of the AMD PDU(s) containing the RLC SDU or SDU segment was stopped or abandoned, the transmitting side of an AM RLC entity skips to send an indication to the upper layers of successful delivery of the RLC SDU.

In an embodiment herein, when receiving a positive acknowledgement for an RLC SDU with SN=x, for which the transmission or retransmission of the AMD PDU containing the RLC SDU or SDU segment was stopped or abandoned, the transmitting side of an AM RLC entity sends an indication to the upper layers of successful discard of the RLC SDU.

When the discard_wait_timer1 expires and discard_wait_sn is greater or equal to x (where x is SN of RLC SDU for which the transmission or retransmission of the AMD PDU(s) containing the RLC SDU or SDU segment was stopped or abandoned), the transmitting side of an AM RLC entity sends an indication to the upper layers of successful discard of the RLC SDU.

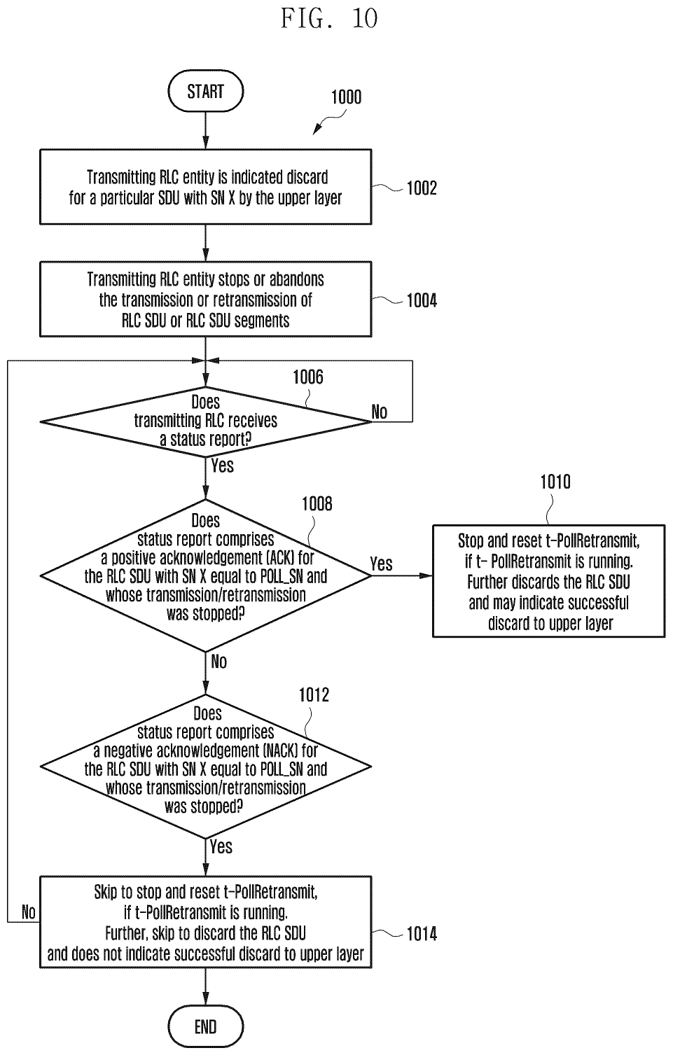

FIG. 10 depicts a method 1000 for an enhanced RLC transmit operation to handle RLC SDU discard at the transmitting side of an AM RLC entity for XR according to an embodiment of the disclosure.

The transmitting side of an AM RLC entity 110 is indicated discard for a particular SDU with SN X by the upper layer, as depicted in operation 1002. The transmitting side of an AM RLC entity 110 stops or abandons the transmission or retransmission of RLC SDU or RLC SDU segments, as depicted in operation 1004, based on the discard indication. The method 1000 verifies whether the transmitting side of an AM RLC entity 110 receives a status report, as depicted in operation 1006. The method 1000 verifies whether the status report comprises a positive acknowledgement (ACK) for the RLC SDU with SN X equal to POLL_SN and whose transmission/retransmission was stopped, as depicted in operation 1008, if the status report has been received. Otherwise, the method 1000 repeats verifying for the status report, as depicted in operation 1006, if the status report has not been received.

The transmitting side of an AM RLC entity 110 stops and resets t-PollRetransmit, if t-PollRetransmit is running, discards the RLC SDU, and indicates successful discard to the upper layer, as depicted in operation 1010, if the status report comprises a positive acknowledgement (ACK) for the RLC SDU with SN X equal to POLL_SN and whose transmission/retransmission was stopped. The method 1000 verifies whether the status report comprises a negative acknowledgement (NACK) for the RLC SDU with SN X equal to POLL_SN and whose transmission/retransmission was stopped, as depicted in operation 1012, if the status report does not comprise a positive acknowledgement (ACK) for the RLC SDU with SN X equal to POLL_SN and whose transmission/retransmission was stopped.

The transmitting side of an AM RLC entity 110 stops and resets t-PollRetransmit, if t-PollRetransmit is running, skips to discard the RLC SDU, and does not indicate successful discard to the upper layer, as depicted in operation 1014, if the status report comprises a negative acknowledgement (NACK) for the RLC SDU with SN X equal to POLL_SN and whose transmission/retransmission was stopped. The method 1000 repeats from operation 1006, after skipping stop and reset of the t-PollRetransmit.

The various actions in method 1000 may be performed in the order presented, in a different order or simultaneously. Further, in some embodiments, some actions listed in FIG. 10 may be omitted.

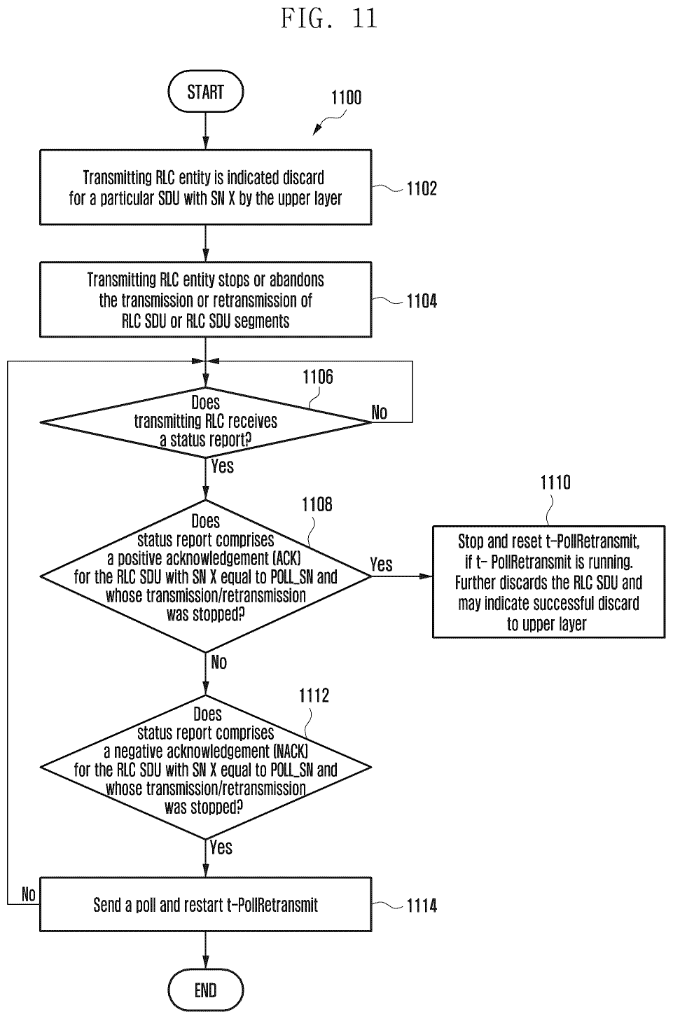

FIG. 11 depicts an alternate method 1100 for an enhanced RLC transmit operation to handle the RLC SDU discard at the transmitting side of an AM RLC entity for XR according to an embodiment of the disclosure.

The transmitting RLC entity 110 is indicated discard for a particular SDU with SN X by the upper layer, as depicted in operation 1102. The transmitting side of an AM RLC entity 110 stops or abandons the transmission or retransmission of RLC SDU or RLC SDU segments, as depicted in operation 1104, based on the discard indication. The method 1100 verifies whether the transmitting RLC entity 110 receives a status report, as depicted in operation 1106. The method 1100 verifies whether the status report comprises a positive acknowledgement (ACK) for the RLC SDU with SN X equal to POLL_SN and whose transmission/retransmission was stopped, as depicted in operation 1108, if the status report has been received. Otherwise, the method 1100 repeats verifying for the status report, as depicted in operation 1106, if the status report has not been received.

The transmitting side of an AM RLC entity 110 stops and resets t-PollRetransmit, if t-PollRetransmit is running, discards the RLC SDU, and indicates successful discard to the upper layer, as depicted in operation 1110, if the status report comprises a positive acknowledgement (ACK) for the RLC SDU with SN X equal to POLL_SN and whose transmission/retransmission was stopped. The method 1100 verifies whether the status report comprises a negative acknowledgement (NACK) for the RLC SDU with SN X equal to POLL_SN and whose transmission/retransmission was stopped, as depicted in operation 1112, if the status report does not comprise a positive acknowledgement (ACK) for the RLC SDU with SN X equal to POLL_SN and whose transmission/retransmission was stopped.

The transmitting side of an AM RLC entity 110 sends a poll, and restarts the t-PollRetransmit, as depicted in operation 1114, if the status report comprises a negative acknowledgement (NACK) for the RLC SDU with SN X equal to POLL_SN and whose transmission/retransmission was stopped. The method 1100 repeats from operation 1106, after sending a poll and restarting the t-PollRetransmit.

The various actions in method 1100 may be performed in the order presented, in a different order or simultaneously. Further, in some embodiments, some actions listed in FIG. 11 may be omitted.

In an embodiment herein, the transmitting side of an AM RLC entity skips considering the RLC data PDUs (comprising of RLC SDU or RLC SDU segments), as pending for transmission or retransmission, once the RLC entity is indicated from the upper layer (for example, PDCP) to discard the particular RLC SDU.

In an embodiment herein, the transmitting side of an AM RLC entity skips considering the RLC data PDUs as pending for retransmission, once the RLC entity has reached a configured threshold number of retransmissions for the RLC data PDUs.

In an embodiment herein, the transmitting side of an AM RLC entity skips considering the RLC data PDUs as pending for transmission or retransmission, once the RLC entity has stopped or abandoned the transmission and/or retransmission of AMD PDU(s) (for example, AMD PDU(s) containing RLC SDU(s) or RLC SDU segments for which discard indication is received from upper layer).

In an embodiment, for MAC BSR, the UE 102 skips considering the RLC data PDUs that are stopped or abandoned for transmission and/or retransmission.

In an embodiment herein, for MAC BSR, the UE 102 skips considering the RLC SDUs that are stopped or abandoned for transmission.

In another embodiment herein, for MAC DSR, the UE 102 skips considering the RLC data PDUs that are stopped or abandoned for transmission and/or retransmission.

In an embodiment, for MAC DSR, the UE 102 skips considering the RLC SDUs that are stopped or abandoned for transmission.

In an embodiment herein, for the purpose of MAC DSR, the UE 102 skips considering the delay-critical RLC SDUs that are stopped or abandoned for transmission.

In an embodiment herein, for the purpose of MAC DSR, the UE 102 skips considering the delay-critical RLC SDUs and delay-critical RLC SDU segments that have not yet been included in an RLC data PDU, and that are stopped or abandoned for transmission.

The RLC SDUs and/or RLC SDU segments that were indicated as delay-critical by the upper layer (for example, PDCP) are no longer considered as delay-critical, when the indication from the upper layer (for example, PDCP) for discarding of the pertinent RLC SDU(s) is received.

In another embodiment herein, the RLC SDUs and/or RLC SDU segments that were indicated as delay-critical by the upper layer (for example, PDCP) are no longer considered as delay-critical, when the transmission and/or retransmission of the corresponding AMD PDUs (comprising of the RLC SDUs and/or RLC SDU segments) is stopped or abandoned.

In an embodiment herein, the RLC SDUs and/or RLC SDU segments that were indicated as delay-critical by the upper layer (for example, PDCP) are no longer considered as delay-critical, once the RLC entity has reached a configured threshold number of retransmissions corresponding AMD PDUs (comprising of the RLC SDUs and/or RLC SDU segments).

An example of the disclosed specification for the transmit operation of the RLC SDU discard handling is provided as follows:

### EXAMPLE 13

When receiving a positive acknowledgement for an RLC SDU with SN=x, which is previously considered for stopping or abandoning of transmission or retransmission, the transmitting side of an AM RLC entity shall:
send an indication to the upper layers that the RLC SDU has been successfully discarded;
set TX_Next_Ack equal to the SN of the RLC SDU with the smallest SN, whose SN falls within the range TX_Next_Ack<=SN<=TX_Next and for which a positive acknowledgment has not been received yet.

In an embodiment herein, the transmitting side of an AM RLC entity skips prioritizing transmission of AMD PDUs containing previously transmitted RLC SDUs or RLC SDU segments that are previously considered for stopping or abandoning of transmission/retransmission over transmission of AMD PDUs (containing not previously transmitted RLC SDUs or RLC SDU segments).

When receiving a negative acknowledgement for an RLC SDU or an RLC SDU segment by a STATUS PDU from its receiving peer AM RLC entity, the transmitting side of an AM RLC entity considers the RLC SDU or the RLC SDU segment for which a negative acknowledgement was received for retransmission, if it is not considered previously for stopping or abandoning of transmission or retransmission and if the SN of the corresponding RLC SDU falls within the range TX_Next_Ack<=SN<=the highest SN of the AMD PDU among the AMD PDUs submitted to lower layer.

### EXAMPLE 14

When receiving a negative acknowledgement for an RLC SDU or an RLC SDU segment by a STATUS PDU from its receiving peer AM RLC entity, the transmitting side of the AM RLC entity shall:
if the SN of the corresponding RLC SDU falls within the range TX_Next_Ack<=SN<=the highest SN of the AMD PDU among the AMD PDUs submitted to lower layer and if it is not considered previously for stopping or abandoning of transmission or retransmission:
   consider the RLC SDU or the RLC SDU segment for which a negative acknowledgement was received for retransmission.

When an RLC SDU or an RLC SDU segment is considered for retransmission, the transmitting side of the AM RLC entity shall:
if the RLC SDU or RLC SDU segment is considered for retransmission for the first time:
   set the RETX_COUNT associated with the RLC SDU to zero.
else, if it (the RLC SDU or the RLC SDU segment that is considered for retransmission) is not pending for retransmission already and the RETX_COUNT associated with the RLC SDU has not been incremented due to another negative acknowledgment in the same STATUS PDU:
   increment the RETX_COUNT;
if RETX_COUNT=maxRetxThreshold:
   indicate to the upper layers that max retransmission has been reached.

In an embodiment herein, the transmitting side of an AM RLC entity (UE 102 or network 104) skips retransmission for a RLC SDU which has been negatively acknowledged, and skips incrementing RETX_COUNT for the RLC SDU when the RLC SDU is previously considered for stopping or abandoning the transmission.

The methods provide RLC enhancements to support low latency retransmissions and reliable data transfer for XR services. The methods improve RLC mechanism so as to achieve quick retransmissions as well as avoid increasing transmission resource burden. Further, the methods improve UE 102, and network performance is improved for XR applications.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a base station, UE capability information for supporting a radio link control (RLC) abandonment;
receiving, from the base station, a radio resource control (RRC) message including configuration information for the RLC abandonment; and
based on a discard indication for the RLC abandonment received from a protocol data convergence protocol (PDCP) layer, stopping, by an RLC layer, a transmission of at least one RLC service data unit (SDU) and corresponding segment.

2. The method of claim 1, wherein the configuration information for the RLC abandonment includes at least one of setup information, release information, modification information, enabling information, activation information, applicability information, timer information, discard confirmation indication, or triggering condition information.

3. The method of claim 1, wherein the RLC layer is at least one of an acknowledged mode (AM) or unacknowledged mode (UM).

4. The method of claim 1, further comprising:
in case that an RLC SDU and corresponding segment has been submitted to a lower layer, stopping, by the RLC layer, a transmission of an acknowledged mode data (AMD) packet data unit (PDU) including the RLC SDU and the corresponding segment indicated for discard.

5. The method of claim 1, further comprising:
in case the RLC layer has reached a threshold number of retransmissions and an RLC SDU and corresponding segment has been submitted to a lower layer, stopping, by the RLC layer, a transmission of an AMD PDU including an RLC SDU indicated for discard,
wherein the threshold number of retransmissions is configured through the RRC message, and
wherein the threshold number of retransmissions is configured for at least one of the RLC layer, a bearer, a logical channel group (LCG), or the UE.

6. The method of claim 1, further comprising:
detecting, by the RLC layer, an expiry of a poll retransmit timer (t-PollRetransmit);
in case that a transmission buffer becomes empty and no new RLC can be transmitted, identifying, by the RLC layer, an RLC SDU for retransmission which has a highest sequence number (SN) among the at least one RLC SDU submitted to a lower layer and not been stopped for the retransmission; and
including, by the RLC layer, a poll in an AMD PDU, based on the identified RLC SDU.

7. A method performed by a base station in a wireless communication system, the method comprising:
receiving, from a user equipment (UE), UE capability information for supporting a radio link control (RLC) abandonment; and
transmitting, to the UE, a radio resource control (RRC) message including configuration information for the RLC abandonment,
wherein the configuration information for the RLC abandonment includes at least one of setup information, release information, modification information, enabling information, activation information, applicability information, timer information, discard confirmation indication, or triggering condition information.

8. The method of claim 7, wherein a transmission of at least one RLC service data unit (SDU) and corresponding segment is stopped at an RLC layer of the UE, based on a discard indication for the RLC abandonment received from a protocol data convergence protocol (PDCP) layer.

9. A user equipment (UE) in a wireless communication system, the UE comprising:
a transceiver, and
a controller coupled with the transceiver, and configured to:
transmit, to a base station, UE capability information for supporting a radio link control (RLC) abandonment,
receive, from the base station, a radio resource control (RRC) message including configuration information for the RLC abandonment, and
based on a discard indication for the RLC abandonment received from a protocol data convergence protocol (PDCP) layer, stop, by an RLC layer, a transmission of at least one RLC service data unit (SDU) and corresponding segment.

10. The UE of claim 9,
wherein the configuration information for the RLC abandonment includes at least one of setup information, release information, modification information, enabling information, activation information, applicability information, timer information, discard confirmation indication, or triggering condition information, and
wherein the RLC layer is at least one of an acknowledged mode (AM) or unacknowledged mode (UM).

11. The UE of claim 9, wherein the controller is further configured to:
in case that an RLC SDU and corresponding segment has been submitted to a lower layer, stop, by the RLC layer, a transmission of an acknowledged mode data (AMD) packet data unit (PDU) including the RLC SDU and the corresponding segment indicated for discard.

12. The UE of claim 9, wherein the controller is further configured to:
in case the RLC layer has reached a threshold number of retransmissions and an RLC SDU and corresponding segment has been submitted to a lower layer, stop, by the RLC layer, a transmission of an AMD PDU including an RLC SDU indicated for discard,
wherein the threshold number of retransmissions is configured through the RRC message, and
wherein the threshold number of retransmissions is configured for at least one of the RLC layer, a bearer, a logical channel group (LCG), or the UE.

13. The UE of claim 9, wherein the controller is further configured to:
detect, by the RLC layer, an expiry of a poll retransmit timer (t-PollRetransmit),
in case that a transmission buffer becomes empty and no new RLC can be transmitted, identify, by the RLC layer, an RLC SDU for retransmission which has a highest sequence number (SN) among the at least one RLC SDU submitted to a lower layer and not been stopped for the retransmission, and
include, by the RLC layer, a poll in an AMD PDU, based on the identified RLC SDU.

14. A base station in a wireless communication system, the base station comprising:
a transceiver, and
a controller coupled with the transceiver, and configured to:
receive, from a user equipment (UE), UE capability information for supporting a radio link control (RLC) abandonment, and
transmit, to the UE, a radio resource control (RRC) message including configuration information for the RLC abandonment,
wherein the configuration information for the RLC abandonment includes at least one of setup information, release information, modification information, enabling information, activation information, applicability information, timer information, discard confirmation indication, or triggering condition information.

15. The base station of claim 14, wherein a transmission of at least one RLC service data unit (SDU) and corresponding segment is stopped at an RLC layer of the UE, based on a discard indication for the RLC abandonment received from a protocol data convergence protocol (PDCP) layer.
